(19) United States
(12) Patent Application Publication
(10) Pub. No.: US 2005/0240708 A1
(43) Pub. Date: Oct. 27, 2005

(54) Systems and methods for providing internal universal serial bus ports

(76) Inventors: Charles Norman Shaver, Cypress, TX (US); Ricardo Marquez, Missouri City, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/829,057

(22) Filed: Apr. 21, 2004

(51) Int. Cl. G06F 13/00

(52) U.S. Cl. 710/313

(57) ABSTRACT

System are provided for providing an internal USB port within a computer chassis. An exemplary system comprises a printed wire board (PWB) that can be used with a computer chassis. The computer chassis internally mounts a first USB header for communicating with an external USB port. The PWB supports a USB hub and a USB port. The PWB is operative to provide passthrough communication between the first USB header and the external USB port. The PWB also is internally mountable within the computer chassis such that the USB port of the PWB operates as an internal USB port. Methods and other systems also are provided.

### BACKGROUND

Many peripheral devices such as cameras and game controllers, for example, interface with computers via communication ports. The universal serial bus (USB) port has become quite popular for providing such interconnectivity. Unfortunately, when an operator attempts to interconnect a USB-compatible device with a computer, the operator may discover that the computer does not possess a USB port for interconnecting with the device.

Typically, adding an external USB port, i.e., a USB port that has a connector mounted externally of the computer chassis, involves using a PCI expansion slot. Specifically, a PCI card that supports an external USB port is placed in one of the PCI expansion slots of the computer chassis. The external USB port then can communicate information from the USB-compatible device via the PCI bus of the computer. A similar procedure also can be used when an internal USB port is required. Unfortunately, a computer typically is limited in the number of PCI expansion slots that are provided. Therefore, occupying one of the PCI expansion slots with a PCI card for adding a USB port can limit other potential capabilities of the computer.

### SUMMARY

Systems for providing universal serial bus (USB) ports are provided. An embodiment of such as system comprises a printed wire board (PWB) that can be used with a computer chassis. The computer chassis internally mounts a first USB header for communicating with an external USB port. The PWB supports a USB hub and a USB port. The PWB is operative to provide passthrough communication between the first USB header and the external USB port. The PWB also is internally mountable within the computer chassis such that the USB port of the PWB operates as an internal USB port.

Another embodiment of such as system comprises a chassis defining an interior. The system also includes a first USB port, a motherboard and a daughter card. The first USB port is externally mounted to the chassis. The motherboard is mounted within the interior of the chassis, with the motherboard having a first USB header for communicating with the first USB port. The daughter card is mounted within the interior of the chassis. The daughter card communicates with the motherboard and has a second USB port, a USB hub, a second USB header, and a third USB header. The USB hub is operative to communicate information to and from the first USB header of the motherboard via the second USB header of the daughter card, and to communicate information to and from the first USB port via the third USB header of the daughter card. The internal USB port is operative to communicate information to and from the motherboard via the USB hub and the second USB header of the daughter card.

Another embodiment of a system is provided for providing an internal USB port within a computer chassis. Such a computer chassis internally mounts a motherboard having a first USB header for communicating with an external USB port. Specifically, the system comprises a printed wire board (PWB) supporting a second USB header, a third USB header, a USB hub and the internal USB port, the PWB being mounted at a location within the computer chassis. The second USB header is operative to communicate with the first USB header. The third USB header is operative to communicate with the external USB port. The USB hub is operative to communicate information to and from the first USB header of the motherboard via the second USB header, and to communicate information to and from the external USB port via the third USB header. The internal USB port is operative to communicate information to and from the motherboard via the USB hub.

Another embodiment of a system is provided for providing an internal USB port within a computer chassis. The computer chassis internally mounts a first USB header for communicating with an external USB port. The system comprises means for providing passthrough communication between the first USB header and the external USB port, the means for providing passthrough communication being internally mountable within a computer chassis such that, when mounted therein, the means for providing passthrough communication additionally provides the internal USB port within the computer chassis.

An embodiment of a method for providing an internal Universal Serial Bus (USB) port within a computer chassis comprises: providing a computer chassis having an external USB port and an internally mounted first USB header for communicating with the external USB port; providing a printed wire board (PWB) supporting a USB hub and a USB port; and internally mounting the PWB within the computer chassis such that the PWB provides passthrough communication between the first USB header and the external USB port, with the USB port of the PWB operating as an internal USB port.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram of an embodiment of a system for providing an internal USB port.

FIG. 2 is a schematic diagram of an embodiment of a daughter card that can be used for providing an internal USB port.

FIG. 3 is a schematic diagram of another embodiment of a daughter card that can be used for providing an internal USB port.

FIG. 4 is a cut-away, perspective view showing the interior of an embodiment of a computer chassis.

FIG. 5 is a cut-away, perspective view of the chassis of FIG. 4, showing an embodiment of a daughter card being used to provide internal USB ports.

### DETAILED DESCRIPTION

As will be described in detail, systems are provided that are capable of adding internal USB port to computers. As used herein, an internal USB port is a USB port that is mounted within the chassis of a computer. An internal USB port typically is used for interfacing with internally mounted components, and usually is not used for interfacing with externally mounted (peripheral) components.

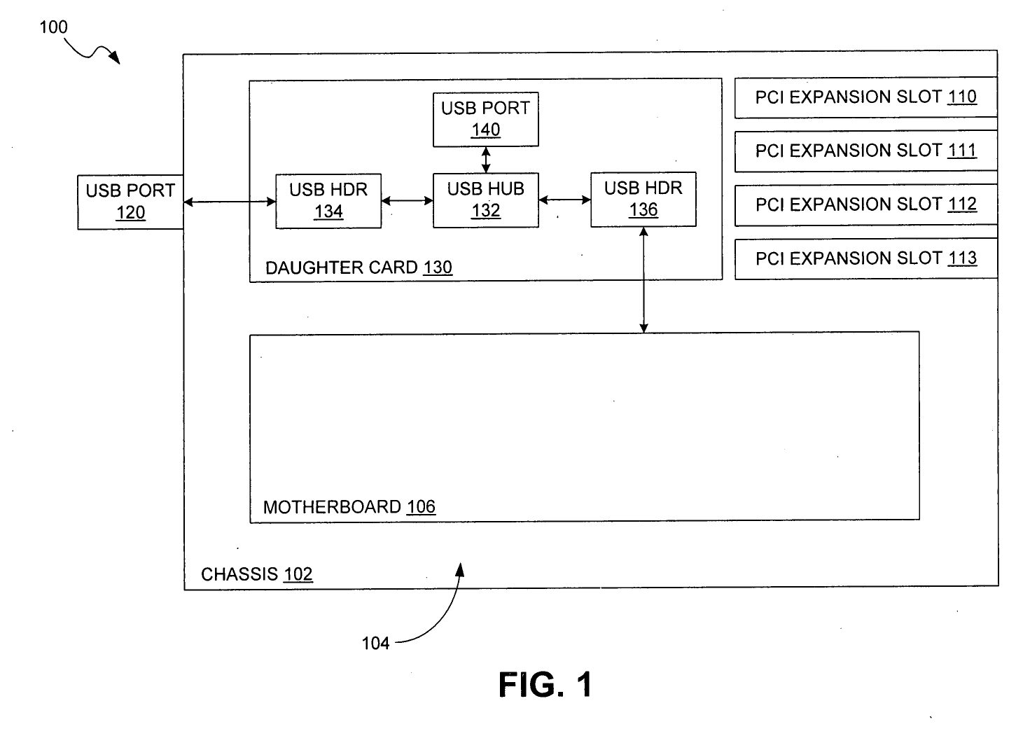

Referring now to the drawings, FIG. 1 is a schematic diagram of an embodiment of a system for providing internal USB ports. In FIG. 1, system 100 includes a computer chassis 102 that defines an interior 104. A motherboard 106 that supports various components, such as a processor, memory, and various interface components (none of which are shown), is mounted within interior 104. Chassis 102 also includes multiple PCI expansion slots, in this case, slots 110-113.

Each PCI expansion slot is adapted to receive a PCI card for interfacing with the motherboard 106 to provide enhanced functionality to the system 100. By way of example, PCI expansion slot 110 could receive a graphics accelerator card that includes a corresponding gaming controller interface. A gaming controller peripheral device then could interface with the system 100 via the gaming controller interface, thereby providing enhanced gaming functionality to the system.

Chassis 102 also mounts a USB port 120. Specifically, USB port 120 is an external USB port, i.e., the connector of the USB port is accessed via the exterior of the chassis and is available for use by peripheral USB-compatible devices. In some embodiments, USB port 120 could be directly interconnected with motherboard 102 via a USB cable. However, in this embodiment, USB port 120 interfaces with motherboard 102 via a daughter card 130.

Daughter card 130 is a printed wire board (PWB) that includes a USB hub 132. USB hub 132 allows passthrough communication between the external USB port 120 and motherboard 102. Specifically, the daughter card includes a front input/output (I/O) USB header 134 and a motherboard USB header 136 that communicate information between each other via the USB hub 132. Communication between the external USB port 120 and the motherboard 102 is facilitated by interconnecting the external USB port 120 with the front input/output (I/O) USB header 134 and interconnecting the motherboard USB header 136 with the motherboard 102.

Advantageously, the daughter card 130 also includes at least one internal USB port. In this case, daughter card 130 provides an internal USB port 140 that communicates with the USB hub 132. Thus, internal USB port 140 can communicate with the motherboard. Since the internal USB port 140 is provided without using a PCI expansion slot, PCI expansion slots remain available to the system 100 for customization.

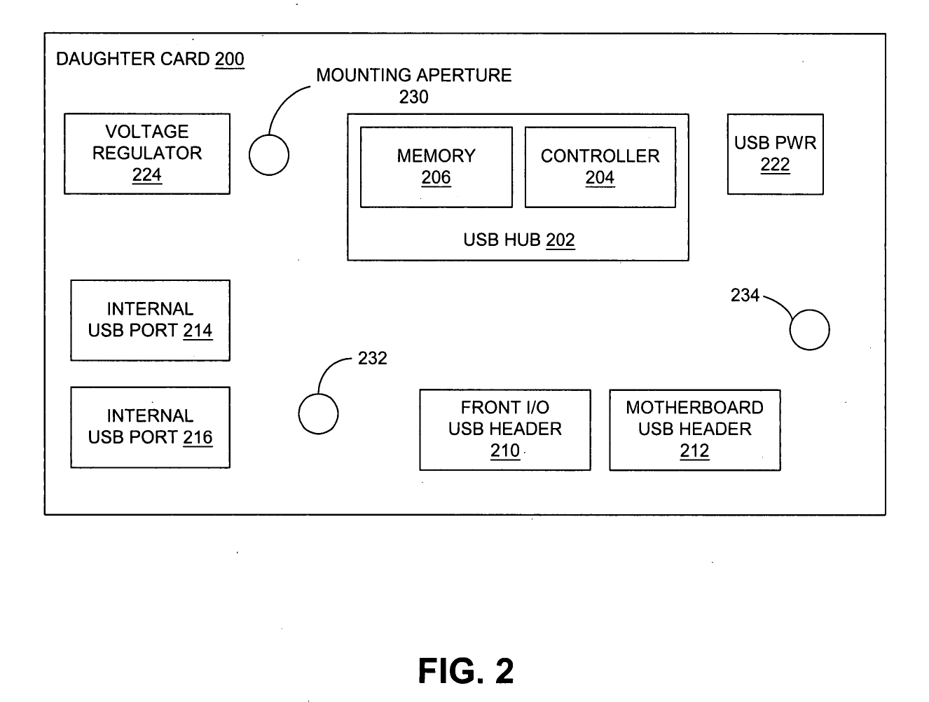

Another embodiment of a daughter card is schematically depicted in FIG. 2. Specifically, daughter card 200 includes a USB hub 202 that incorporates a hub controller 204 and memory 206. Memory 206 is a read-only memory (ROM), such as an EEPROM. USB hub 202 coordinates the routing of data provided to and/or from front I/O USB header 210, motherboard USB header 212, and internal USB ports 214 and 216. As described briefly with reference to the embodiment of FIG. 1, the front I/O USB header 210 interfaces with an external USB port (not shown in FIG. 2). Since various techniques for routing data among various ports and/or headers using a USB hub are known, a detailed discussion of such routing is not provided here.

Daughter card 200 is powered from an associated motherboard in two manners. Specifically, power is provided to the daughter card via a motherboard power interface portion of the motherboard USB header 212, and via a USB power header 222. The power provided by the motherboard USB header 212 is to any external USB ports via front I/O USB header 210. In contrast, power provided by USB power header 222 is routed to a voltage regulator 224. Specifically, voltage regulator 224 receives a 5 volt power signal from the motherboard and regulates that signal to produce a 3.3 volt fixed output.

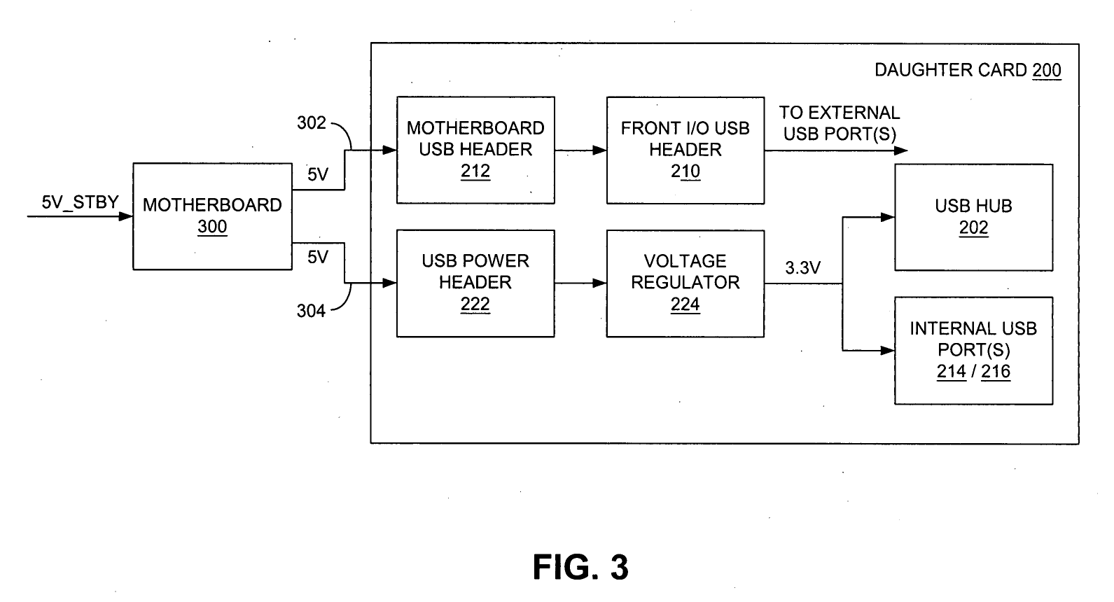

FIG. 3 is a schematic diagram depicting power distribution from an embodiment of a motherboard to an associated daughter card. As shown in FIG. 3, motherboard 300 receives a 5 volt standby voltage (5V_STBY). The 5 volt standby voltage powering the motherboard typically is present regardless of the power state of the motherboard.

Motherboard 300 provides first and second power signals 302 and 304, respectively, to the daughter card 200. Circuitry on the motherboard 300 controls the power signals 302 and 304 so that USB ports are only provided with power during the proper states of operation. By way of example, the motherboard controls the power signals 302 and 304 so that the USB ports are powered during the run state (S0), sleep state (S1) and suspend-to-RAM state (S3). However, voltage is not provided from the motherboard during the soft-off state (S5).

The first power signal 302 is provided to daughter card 200 via the motherboard USB header 212. From header 212, the first power signal 302 is routed to the front I/O USB header and then to any external USB ports (not shown in FIG. 3).

The second power signal 304 is provided to daughter card 200 via USB power header 222, with the second power signal then being provided to voltage regulator 224. From voltage regulator 224, a 3.3 volt fixed output is provided to USB hub 202 and internal USB ports, such as ports 214 and 216.

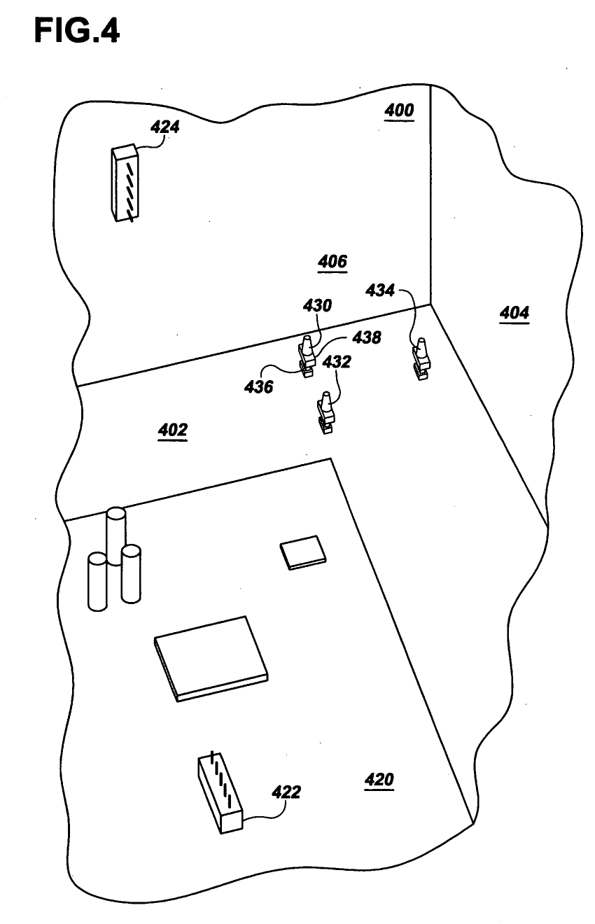

Referring back to FIG. 2, daughter card 200 also includes mounting apertures 230, 232 and 234. The mounting apertures receive the distal ends of mounts that are used to attach the daughter card to a chassis. An embodiment of a chassis that includes mounts is depicted in FIG. 4.

In FIG. 4, chassis 400, only a portion of which is shown, includes a base 402, a side wall 404 and a front wall 406. The base 402, side wall 404 and front wall 406 define an interior 410, within which is mounted a motherboard 420. Note that motherboard 420 includes a motherboard USB header 422 and that front wall 406 includes an external USB port header 424. In typical operation, the external USB port associated with the header 424 communicates with the motherboard 420 via a USB cable (not shown) that interconnects the USB headers 422 and 424. Also note that chassis 400 includes mounts 430, 432 and 434 for mounting a daughter card to the chassis so that internal USB ports are provided without using a PCI expansion slot.

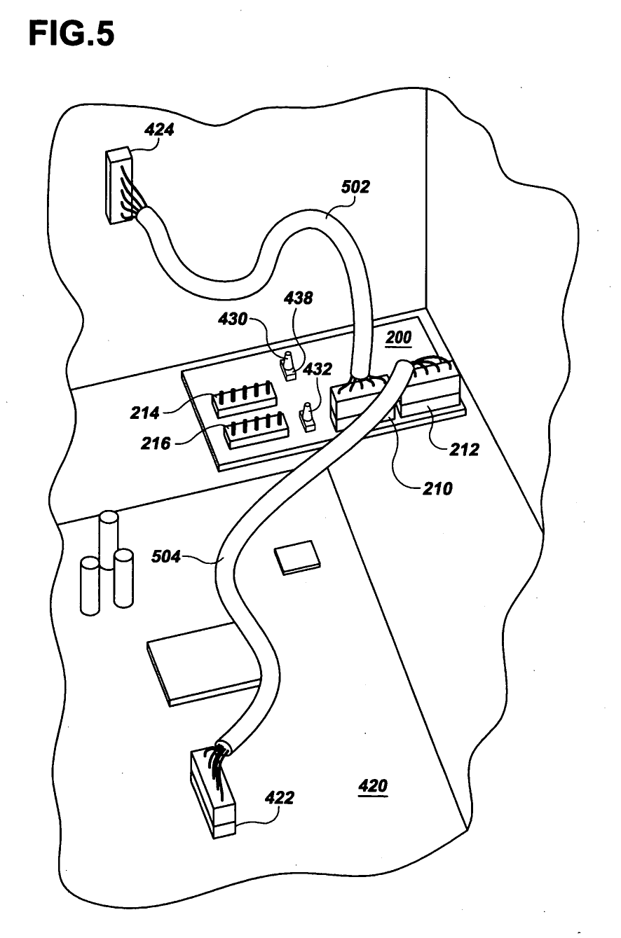

The mounts 430, 432 and 434 are generally shaped as tapered posts. Each of the mounts includes a mounting surface and a corresponding latching surface. For instance, mount 430 includes a mounting surface 436 and a latching surface 438. In operation, a daughter card, e.g., daughter card 200, is oriented so that each of its mounting apertures aligns with one of the mounts. The daughter card is then positioned so that the distal end of each mount is inserted through a corresponding mounting aperture. Thus, with respect to mount 430, the latching surface 438 extends through the aperture 230 and forms an interference fit with the daughter card. In this latched configuration, the daughter card is secured to the chassis as shown in FIG. 5, with mounting surface 436 supporting the underside of the daughter card.

FIG. 5 also depicts interconnection of daughter card 200 with motherboard 420 and USB header 424. In particular, a first USB cable 502 interconnects USB header 422 with USB header 212 of the daughter card, and a second USB cable 504 interconnects front I/O USB header 210 with USB header 424. Thus, internal USB ports 214 and 216 are provided without using a PCI expansion slot of the chassis 400.

It should be emphasized that many variations and modifications may be made to the above-described embodiments. For example, in some embodiments, the daughter card can be mounted to a portion of the chassis other than depicted herein, or can be attached directly to a motherboard, i.e., the daughter card can be configured to interconnect with the USB header of the motherboard without use of a USB cable. All such modifications and variations are intended to be included herein within the scope of this disclosure and protected by the following claims.

1. A system for providing an internal Universal Serial Bus (USB) port within a computer chassis, the computer chassis internally mounting a motherboard having a first USB header for communicating with an external USB port, said system comprising:
a printed wire board (PWB) supporting a second USB header, a third USB header, a USB hub and the internal USB port, the PWB being mountable at a location within the computer chassis;
the second USB header operative to communicate with the first USB header;
the third USB header operative to communicate with the external USB port;
the USB hub operative to communicate information to and from the first USB header of the motherboard via the second USB header, and to communicate information to and from the external USB port via the third USB header; and
the internal USB port being operative to communicate information to and from the motherboard via the USB hub.

2. The system of claim 1, wherein the location at which the PWB is mounted is a location other than a Peripheral Component Interface (PCI) expansion slot of the computer chassis.

3. The system of claim 1, further comprising:
a voltage regulator supported by the PWB, the voltage regulator being operative to receive a first voltage output from the motherboard and to provide, in response thereto, a second, lower voltage output to the USB hub.

4. The system of claim 3, wherein the first voltage output is approximately 5 volts, and the second voltage output is approximately 3.3 volts.

5. The system of claim 3, wherein the PWB is operative to receive a third voltage output from the motherboard, the third voltage output being routed by the PWB to power the external USB port.

6. The system of claim 1, wherein:
the chassis has mounts extending into the interior thereof;
the PWB has apertures formed therethrough, each of the apertures being operative to receive one of the mounts such that insertion of the mounts into the apertures secures the PWB to the chassis.

7. The system of claim 6, wherein the mounts form interference fits with the apertures when the mounts inserted within the apertures.

8. The system of claim 1, further comprising:
a first USB cable operative to interconnect the first USB header of the motherboard with the second USB header; and
a second USB cable operative to interconnect the third USB header with the external USB port.

9. A computer system comprising:
a chassis defining an interior;
a first Universal Serial Bus (USB) port externally mounted to the chassis;
a motherboard mounted within the interior of the chassis, the motherboard having a first USB header for communicating with the first USB port; and
a daughter card mounted within the interior of the chassis, the daughter card communicating with the motherboard and having a second USB port, a USB hub, a second USB header, and a third USB header;
the USB hub being operative to communicate information to and from the first USB header of the motherboard via the second USB header of the daughter card, and to communicate information to and from the first USB port via the third USB header of the daughter card; and
the internal USB port being operative to communicate information to and from the motherboard via the USB hub and the second USB header of the daughter card.

10. The system of claim 9, wherein:
the chassis has a Peripheral Component Interface (PCI) expansion slot; and
the daughter card is mounted at a location other than the PCI expansion slot.

11. The system of claim 9, wherein the motherboard controls continuity of power to the daughter card.

12. The system of claim 9, further comprising:
a voltage regulator supported by the daughter card, the voltage regulator being operative to receive a first voltage output from the motherboard and to provide, in response thereto, a second, lower voltage output to the USB hub.

13. The system of claim 12, wherein the first voltage output is approximately 5 volts, and the second voltage output is approximately 3.3 volts.

14. The system of claim 9, wherein the daughter card is operative to receive a third voltage output from the motherboard, the third voltage output being routed by the daughter card to power the first USB port.

15. The system of claim 9, further comprising:
means for securing the daughter card to the chassis.

16. The system of claim 9, wherein:
the system further comprises a mount extending into the interior of the chassis; and
the daughter card has an aperture for receiving the mount such that insertion of the mount into the aperture secures the daughter card to the chassis.

17. The system of claim 16, wherein the mount forms an interference fit with the aperture when inserted therein.

18. The system of claim 9, further comprising:
a first USB cable operative to interconnect the first USB header of the motherboard with the second USB header of the daughter card; and
a second USB cable operative to interconnect the third USB header of the daughter card with the first USB port.

19. A system for providing an internal Universal Serial Bus (USB) port within a computer chassis, the computer chassis internally mounting a first USB header for communicating with an external USB port, said system comprising:
a printed wire board (PWB) supporting a USB hub and a USB port, the PWB being operative to provide passthrough communication between the first USB header and the external USB port, the PWB being internally mountable within a computer chassis such that the USB port of the PWB operates as an internal USB port.

20. A system for providing an internal Universal Serial Bus (USB) port within a computer chassis, the computer chassis internally mounting a first USB header for communicating with an external USB port, said system comprising:
means for providing passthrough communication between the first USB header and the external USB port, the means for providing passthrough communication being internally mountable within a computer chassis such that, when mounted therein, the means for providing passthrough communication additionally provides the internal USB port within the computer chassis.

21. A method for providing an internal Universal Serial Bus (USB) port within a computer chassis, said method comprising:
providing a computer chassis having an external USB port and an internally mounted first USB header for communicating with the external USB port;
providing a printed wire board (PWB) supporting a USB hub and a USB port; and
internally mounting the PWB within the computer chassis such that the PWB provides passthrough communication between the first USB header and the external USB port, with the USB port of the PWB operating as an internal USB port.

22. The method of claim 21, wherein:
the computer chassis has mounts extending into the interior thereof;
the PWB has apertures formed therethrough; and
internally mounting the PWB within the computer chassis comprises inserting the mounts into the apertures to secure the PWB to the computer chassis.

23. The method of claim 21, wherein internally mounting the PWB within the computer chassis comprises:
interconnecting a first USB cable between the first USB header and the PWB; and
interconnecting a second USB cable between the PWB and the external USB port.
